(19) United States
(12) Patent Application Publication
(10) Pub. No.: US 2020/0250551 A1
(43) Pub. Date: Aug. 6, 2020

(54) KNOWLEDGE ACQUISITION DEVICE, KNOWLEDGE ACQUISITION METHOD, AND RECORDING MEDIUM

(71) Applicant: NEC Corporation, Tokyo (JP)

(72) Inventors: Yutaro NEMOTO, Tokyo (JP); Itaru HOSOMI, Tokyo (JP)

(73) Assignee: NEC Corporation, Tokyo (JP)

(21) Appl. No.: 16/641,825

(22) PCT Filed: Sep. 21, 2017
(86) PCT No.: PCT/JP2017/034077

§ 371 Date: Feb. 25, 2020

(51) Int. Cl. G06N 5/04

(52) U.S. Cl. CPC G06N 5/04

(57) ABSTRACT

Provided is a knowledge acquisition device for acquiring knowledge for performing reasoning taking into account characteristics of persons. A knowledge acquisition device 100 includes an acquisition unit 120 and an update unit 130. The acquisition unit 120 acquires knowledge representing a relationship between events relating to persons. The update unit 130 identifies, based on an attribute value possessed by each of a plurality of persons, an attribute value possessed by a person for whom the knowledge holds true among the plurality of persons. The acquisition unit 120 updates the knowledge in such a way that the updated knowledge holds true for a person having the identified attribute value, and outputs the updated knowledge.

### TECHNICAL FIELD

The present invention relates to a knowledge acquisition device, a knowledge acquisition method, and a recording medium.

### BACKGROUND ART

A reasoning system represented by an expert system and the like executes reasoning based on a predetermined rule, from a set of knowledges expressed by a logical formula. One example of a general reasoning system is described in NPL 1. The reasoning system of NPL 1 is composed of a reasoning engine that executes reasoning by connecting knowledge to a knowledge base that stores knowledge expressing a relationship between events as a logical formula. Such reasoning system supports solution to a user problem by receiving observation expressed by a logical formula as an input, and outputting a reasoning result that is the most reasonable, which is derived from the observation logical formula and a set of knowledges stored in a knowledge base.

Such a reasoning system, as described in PTLs 1 and 2, has been applied in a field in which expert knowledge is effective, such as medical diagnosis, facility fault diagnosis, or design assistance. Further, in response to the development of a natural language processing technique or the improvement of corpuses (which are obtained by structuring sentences and integrating them in large scale) in various fields in recent years, operation of a reasoning system using a wide variety of knowledges from a general commonsensical knowledge to an expert knowledge is becoming possible. For example, NPL 2 proposes a method of focusing on a specific expression in a sentence described in a natural language, and acquiring, from the sentence, knowledge relating to causality between events. In such manner, it becomes possible to efficiently acquire and store various knowledges and thus practical application of a reasoning system in a wide range of industrial fields can be expected.

Note that, as a related literature, in PTL 3, a technique of generating a model for estimating a user profile from a document is disclosed. In PTL 4, a technique of determining a hierarchy for grouping in a data mining system is disclosed. In PTL 5, a technique of solving a problem by integrating various information processing systems in an information processing device is disclosed. In PTL 6, a technique of generating a class estimation rule by using an attribute value for which a case of taking an effective attribute value exists, in a knowledge processing system, is disclosed.

### CITATION LIST

### Patent Literature

[PTL 1] Japanese Unexamined Patent Application Publication No. S63-261453
[PTL 2] Japanese Unexamined Patent Application Publication No. H01-121972
[PTL 3] Japanese Unexamined Patent Application Publication No.

2014-219871
[PTL 4] Japanese Unexamined Patent Application Publication No. 2011-034457
[PTL 5] Japanese Unexamined Patent Application Publication No. 2001-022585
[PTL 6] Japanese Unexamined Patent Application Publication No. H07-160503

### Non Patent Literature

[NPL 1] Katsumi NITTA, “Knowledge Expression and Reasoning in Expert System”, Information Processing, Information Processing Society of Japan, 1987, Vol. 28, Second issue, pp. 158 to 166
[NPL 2] Koji INUI, Kentaro INUI, Yuji MATSUMOTO, “Acquiring Causal Knowledge from Text Using the Connective Marker tame, Journal of Information Processing Society, Information Processing Society of Japan, 2004, Vol. 43, Third issue, pp. 919 to 933

### SUMMARY OF INVENTION

### Technical Problem

The reasoning system described above is meant for application in school education or interpersonal services represented by human resource development, care, or the like. In such interpersonal services, an event relating to a situation surrounding a target person or a personal status is observed, and is input to the reasoning system. The reasoning system uses a set of knowledges stored in a knowledge base, and performs estimation of a reason of a status change that occurs with the person or prediction of a status change that will subsequently occur with the person. In this case, a relationship (a feature relating to a personal service target) between events is different depending on an individual person (hereinafter, referred to as an individual) and a group of persons. Therefore, it is desirable to perform reasoning by using knowledge considering features of an individual or a group.

However, in the PTLs or NPLs described above, acquiring knowledge considering features of an individual person or a group, as knowledge, is nowhere disclosed. Thus, in the interpersonal service applying the reasoning systems of the PTLs or NPLs described above, reasoning based on general knowledge such as a trend applicable to many persons or common sense is performed.

An object of the present invention is to solve the problem described above and provide a knowledge acquisition device, a knowledge acquisition method, and a recording medium by which knowledge for performing reasoning considering personal features can be acquired.

### Solution to Problem

A knowledge acquisition device according to an exemplary aspect of the present invention includes: acquisition means for acquiring knowledge representing a relationship between events relating to persons; and update means for identifying, based on an attribute value possessed by each of a plurality of persons, an attribute value possessed by a person for whom the knowledge holds true among the plurality of persons, updating the knowledge in such a way that the updated knowledge holds true for a person having the identified attribute value, and outputting the updated knowledge.

A knowledge acquisition method according to an exemplary aspect of the present invention includes: acquiring knowledge representing a relationship between events relating to persons; identifying, based on an attribute value possessed by each of a plurality of persons, an attribute value possessed by a person for whom the knowledge holds true among the plurality of persons; updating the knowledge in such a way that the updated knowledge holds true for a person having the identified attribute value; and outputting the updated knowledge.

A computer readable storage medium according to an exemplary aspect of the present invention records thereon a program, causing a computer to execute processes including: acquiring knowledge representing a relationship between events relating to persons; identifying, based on an attribute value possessed by each of a plurality of persons, an attribute value possessed by a person for whom the knowledge holds true among the plurality of persons; updating the knowledge in such a way that the updated knowledge holds true for a person having the identified attribute value; and outputting the updated knowledge.

### Advantageous Effects of Invention

An advantageous effect of the present invention is that knowledge for performing reasoning considering personal features can be acquired.

### BRIEF DESCRIPTION OF DRAWINGS

FIG. 1 is a block diagram illustrating a configuration of a first example embodiment.

FIG. 2 is a diagram illustrating an example of a database 201 in the first example embodiment.

FIG. 3 is a diagram illustrating an example of a knowledge expression vocabulary in the first example embodiment.

FIG. 4 is a diagram illustrating an example of a range vocabulary in the first example embodiment.

FIG. 5 is a block diagram illustrating a configuration of a knowledge acquisition device 100 implemented in a computer in the first example embodiment.

FIG. 6 is a flowchart illustrating knowledge acquisition/update processing in the first example embodiment.

FIG. 7 is a diagram illustrating an example of a knowledge acquisition result in the first example embodiment.

FIG. 8 is a diagram illustrating an example of an effective range determination result in the first example embodiment.

FIG. 9 is a diagram illustrating an example of a knowledge update result in the first example embodiment.

FIG. 10 is a block diagram illustrating a basic configuration of the first example embodiment.

FIG. 11 is a block diagram illustrating a configuration of a second example embodiment.

FIG. 12 is a diagram illustrating an example of an observation logical formula 401 in the second example embodiment.

FIG. 13 is a flowchart illustrating reasoning processing in the second example embodiment.

FIG. 14 is a diagram illustrating an example of knowledge stored in a knowledge base 301 in the second example embodiment.

FIG. 15 is a diagram illustrating an example of reasoning in the second example embodiment.

FIG. 16 is a block diagram illustrating a configuration of a third example embodiment.

FIG. 17 is a diagram illustrating an example of an observation logical formula 411 in the third example embodiment.

FIG. 18 is a diagram illustrating an example of reasoning target attribute information 412 in the third example embodiment.

FIG. 19 is a flowchart illustrating reasoning processing in the third example embodiment.

FIG. 20 is a diagram illustrating an example of a pseudo observation logical formula 413 in the third example embodiment.

FIG. 21 is a diagram illustrating an example of reasoning in the third example embodiment.

### EXAMPLE EMBODIMENT

Example embodiments of the present invention will be described in detail with reference to the drawings. Note that in the drawings and example embodiments described in this specification, identical reference numerals are assigned to similar constituent elements, and the description is omitted as appropriate.

Hereinafter, each example embodiment will be described by way of example of a learning service that performs learning guidance for a person (learner). In the learning service, knowledge for performing reasoning is acquired (generated) based on data representing each person's features relating to learning, which are acquired from a person group (learner group), and learning guidance for persons is performed by executing reasoning based on the acquired knowledge.

In addition, in the following example embodiments, knowledge is a relationship between events relating to a situation surrounding a person or a status of the person in a target area for performing reasoning. An event is represented, as in “x studies y”, for example, by a predicate (in this case, studies) and one or more arguments each being an event description object (in this case, x and y). Knowledge represents a relationship such as causality between a presumptive event and a consequent event or context of the events, and has a format such as “if an event A takes place, an event B takes place” or “if the event A holds true (is true), the event B holds true (is true)”. In reasoning, for example, an event or knowledge described in a first-order predicate logic, as described in NPL 1, is used.

Note that an event or knowledge may be described by another method such as a production rule or a higher-order logic, as long as the event or knowledge can be expressed by the causality between events or context of the events as described above.

### First Example Embodiment

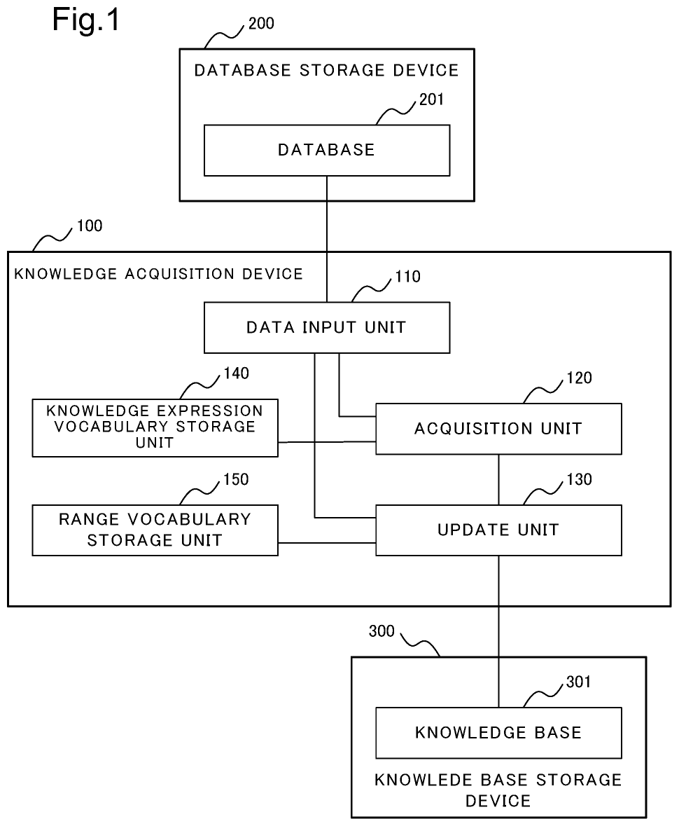

A first example embodiment will be described. First, a configuration of the first example embodiment will be described. FIG. 1 is a block diagram illustrating the configuration of the first example embodiment.

Referring to FIG. 1, a knowledge acquisition device 100 is connected to a database storage device 200 and a knowledge base storage device 300 via a network and the like. The knowledge acquisition device 100 acquires (generates) knowledge, based on data representing personal features input from the database storage device 200. The knowledge acquisition device 100 updates the acquired knowledge to knowledge considering features of an individual or a group, and outputs the updated knowledge to the knowledge base storage device 300.

The database storage device 200 stores a database 201. The database 201 represents attribute information and feature information of each of a plurality of persons that are knowledge acquisition/update targets. The database 201 is preset by an administrator and the like.

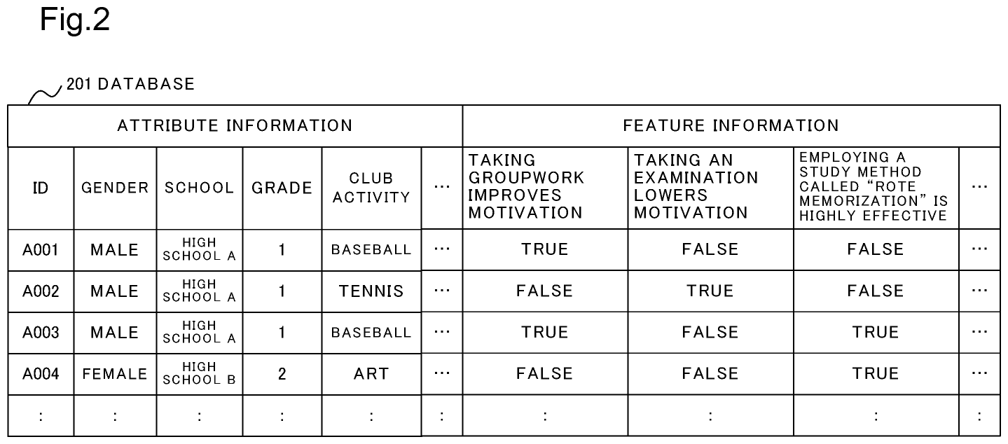

FIG. 2 is a diagram illustrating an example of the database 201 in the first example embodiment. In the database 201 of FIG. 2, for each of the plurality of persons, the attribute information and the feature information of the person are associated.

The attribute information indicates a value of the attribute possessed by a person for each of a plurality of attributes (hereinafter, referred to as attribute value(s)). An attribute indicates a personal identifier (hereinafter, referred to as Identifier (ID)) or a group to which a person belongs. In the example of FIG. 2, “ID”, “gender”, “school”, “club activity”, and the like are set as attributes. Further, for example, “high school A”, “high school B”, . . . and the like are set for attribute values of the attribute “school”; and “baseball”, “tennis”, . . . and the like are set for attribute values of the attribute “club activity”.

The feature information indicates, for each of a plurality of features, whether or not a person has the feature (whether or not the feature exists). A feature is represented by a relationship between events relating to a personal situation or status. In the example of FIG. 2, features relating to learning, which are required to provide a learning service, such as “taking group work improves motivation”, “taking an examination lowers motivation”, “employing a study method called “rote memorization” is highly effective”, are set as features.

The features in the feature information each may be set, for example, by an analyzing device (not shown) outside the knowledge acquisition device 100 extracting an event and a relationship between events from books, articles relating to general education or learning, or the like. Similarly, the presence or absence of each feature may be set by, for example: the analyzing device extracting an event and a relationship between events, from documents and the like in which an observation result of a situation or a status relating to learning of each person is described; and determining whether or not a relationship between events of each feature holds true.

In addition, the features in the feature information each may be defined and set by a learning service provider and the like. Similarly, the presence or absence of each of the features of each person may be set by an educator and the like who observes a situation or a status relating to learning of each person.

Note that the format of the database 201 may be a format other than the table as in FIG. 2, as long as the format can represent the attribute information and feature information of each person.

The knowledge acquisition device 100 includes a data input unit 110, an acquisition unit 120, an update unit 130, a knowledge expression vocabulary storage unit 140, and a range vocabulary storage unit 150.

The data input unit 110 acquires each of the features of the feature information in the database 201 from the database storage device 200, and inputs the acquired features to the acquisition unit 120. Further, the data input unit 110 acquires the attribute information and feature information of each person in the database 201, and inputs the acquired pieces of information to the update unit 130.

The knowledge expression vocabulary storage unit 140 stores a knowledge expression vocabulary for each of the events included in each of the features in the feature information. The knowledge expression vocabulary is vocabulary expressing a predicate of each of the events included in each of the features of the feature information by a format (logical formula) that can be used in reasoning.

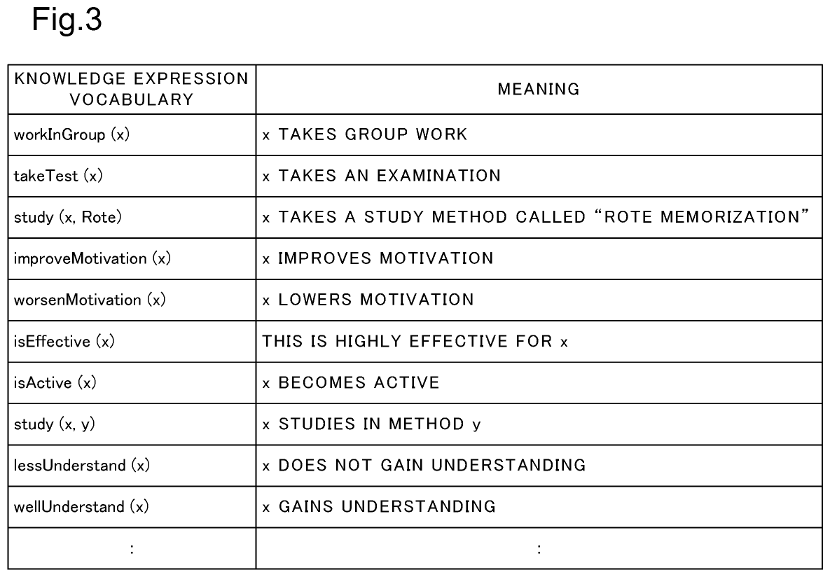

FIG. 3 is a diagram illustrating an example of a knowledge expression vocabulary in the first example embodiment. In FIG. 3, “x” is an argument that represents a person.

The knowledge expression vocabulary is preset by an administrator and the like, based on the feature information of the database 201.

The acquisition unit 120 acquires (generates) knowledge by applying the knowledge expression vocabulary stored in the knowledge expression vocabulary storage unit 140 to each of the features included in the feature information acquired from the database 201.

Note that the acquisition unit 120 may acquire, from another device (not shown), knowledge having applied a knowledge expression vocabulary, which corresponds to each feature.

The range vocabulary storage unit 150 stores a range vocabulary for each of the attribute values of the attributes in the attribute information. The range vocabulary is a vocabulary expressing that a person has a specific attribute value (has an ID expressed by the attribute value or belongs to a group expressed by the attribute value) by a format (logical formula) available in reasoning. The range vocabulary is used to specify an effective range of the knowledge acquired by the acquisition unit 120.

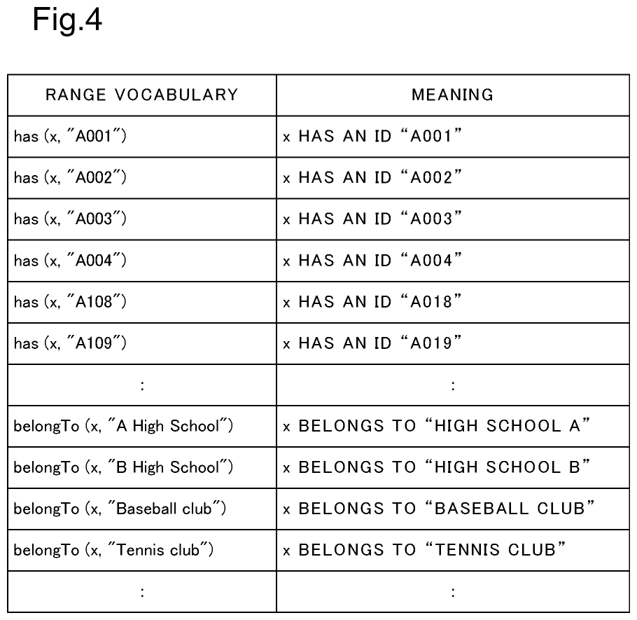

FIG. 4 is a diagram illustrating an example of a range vocabulary in the first example embodiment.

The range vocabulary is preset by an administrator and the like, based on the attribute information of the database 201, for example.

The update unit 130 determines the effective range of each feature, based on the attribute information and the feature information of each of the persons acquired by the data input unit 110. The update unit 130 updates the knowledge acquired by the acquisition unit 120, by using the determined effective range and the range vocabulary stored in the range vocabulary storage unit 150. Here, the update unit 130 updates knowledge by setting the logical formula of the effective range converted by the range vocabulary for a presumptive event of the knowledge. The update unit 130 outputs the updated knowledge to the knowledge base storage device 300.

The knowledge base storage device 300 stores a knowledge base 301. The knowledge base 301 includes the knowledge with the effective range output by the knowledge acquisition device 100.

Note that the knowledge acquisition device 100 may be a computer including a Central Processing Unit (CPU) and a recording medium that stores a program, which is operated by control based on a program.

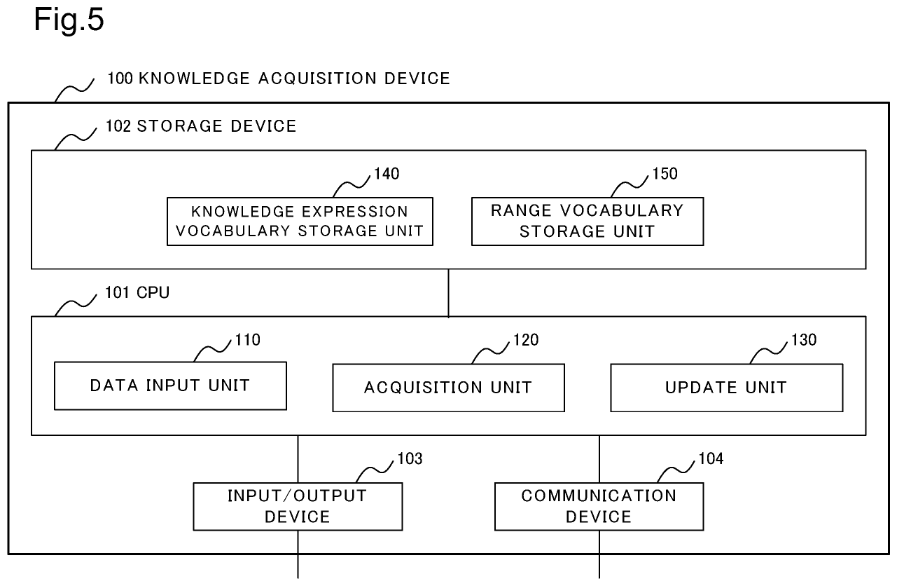

FIG. 5 is a block diagram illustrating a configuration of the knowledge acquisition device 100 implemented in a computer in the first example embodiment.

Referring to FIG. 5, the knowledge acquisition device 100 includes a CPU 101, a storage device 102 (recording medium), an input/output device 103, and a communication device 104. The CPU 101 executes an instruction of a program for implementing the data input unit 110, an acquisition unit 120, and the update unit 130. The storage device 102 is a hard disk, memory, or the like, for example, and stores the data of the knowledge expression vocabulary storage unit 140 and the range vocabulary storage unit 150. The input/output device 103 is a keyboard, display, or the like, for example, and accepts data input of the knowledge expression vocabulary storage unit 140 and the range vocabulary storage unit 150 from an administrator and the like. The communication device 104 receives the feature information and the attribute information of the database 201 from the database storage device 200. The communication device 104 also transmits the updated knowledge to the knowledge base storage device 300.

In addition, in the knowledge acquisition device 100, a part or all of the constituent elements may be implemented by a general-purpose or dedicated circuitry or processor, or in combination of the circuitry and processor. These circuitry and processor may be composed of a single chip or may be composed of a plurality of chips connected via a bus. A part or all of the constituent elements may also be implemented in combination of the above circuitry and the like and a program. In a case where a part or all of the constituent elements is implemented by a plurality of information processing devices or circuitries and the like, the plurality of information processing devices or circuitries and the like may be intensively arranged or may be separately arranged. For example, an information processing device or circuitry and the like may be implemented in a form in which each is connected via a communication network such as a client and server system or a cloud computing system.

Similarly, the database storage device 200 and the knowledge base storage device 300 may be computers, each of which includes a CPU and a recording medium that stores a program, and is operated by executing an instruction of a program as well.

Further, a part or all of the knowledge acquisition device 100, the database storage device 200, and the knowledge base storage device 300 may be composed of one device.

Next, an operation of the first example embodiment will be described.

Here, it is assumed that the database 201 of FIG. 2 is stored in the database storage device 200. Further, it is assumed that the knowledge expression vocabulary of FIG. 3 and the range vocabulary of FIG. 4 are respectively stored in the knowledge expression vocabulary storage unit 140 and the range vocabulary storage unit 150.

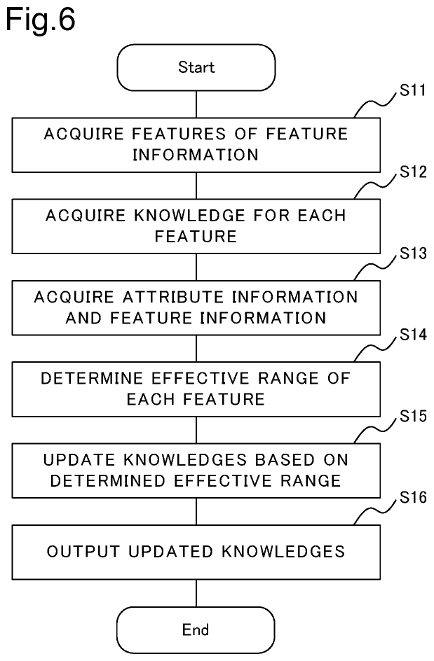

FIG. 6 is a flowchart illustrating knowledge acquisition/update processing in the first example embodiment.

First, the data input unit 110 of the knowledge acquisition device 100 acquires each of the features of the feature information in the database 201 from the database storage device 200, and inputs the acquired feature to the acquisition unit 120 (step S11). For example, the data input unit 110 acquires the feature of the database 201 of FIG. 2 “taking group work improves motivation”, “taking an examination lowers motivation”, or “employing a study method called “rote memorization” is highly effective”.

Next, the acquisition unit 120 acquires (generates) knowledge for each of the input features (step S12). Here, the acquisition unit 120 searches, for each feature, a knowledge expression vocabulary (predicate vocabulary) corresponding to the feature from the knowledge expression vocabulary storage unit 140 and applies the searched vocabulary to the feature, thereby converting the feature to the knowledge expressed by a logical formula. In this case, the acquisition unit 120 may convert each feature, for example, referring to a correspondence relationship between the natural language and the predicate vocabulary that are predefined in the knowledge expression vocabulary storage unit 140. Note that the acquisition unit 120 may cause a conversion device (not shown) outside the knowledge acquisition device 100 to execute such conversion to the knowledge of each feature.

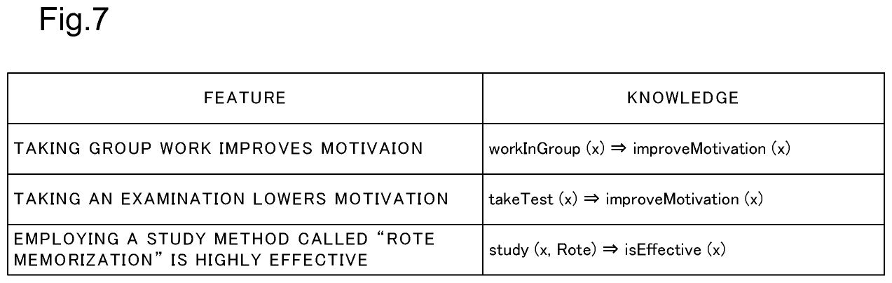

FIG. 7 is a diagram illustrating an example of a knowledge acquisition result in the first example embodiment. For example, the acquisition unit 120 applies the knowledge expression vocabulary of FIG. 3 to each of the features in the database 201 of FIG. 2, and acquires knowledges as in FIG. 7. In each of the knowledges of FIG. 7, the left side of a sign “=>” indicates a presumptive event, and the right side of the sign indicates a consequent event.

Next, the data input unit 110 acquires the attribute information and the feature information of each of the persons in the database 201, and inputs the acquired information to the update unit 130 (step S13).

For example, the data input unit 110 acquires the attribute information and the feature information of each of the persons in the database 201 of FIG. 2.

Next, the update unit 130 determines the effective range of each of the features of the feature information (step S14).

Here, in a case where there is an attribute value possessed by all or a predetermined percentage or more of the persons having a certain feature (for whom knowledge corresponding to the feature holds true), it is considered that there is a high possibility that a group of the persons possessing the attribute value has the feature. On the other hand, in a case where there is no attribute value possessed by all or a predetermined percentage or more of the persons having a certain feature (for whom knowledge corresponding to the feature holds true), it is considered that the feature is a feature of an individual having the feature.

Then, the update unit 130 identifies, for each feature, an attribute value possessed by a person having the feature, and extracts attribute values possessed by all or a predetermined percentage or more of persons having the feature. Afterwards, the update unit 130 determines, as an effective range of the feature, possession of all of the extracted attribute values.

In addition, the update unit 130 determines, for each feature, as an effective range of the feature, possession of any ID of a person having the feature in a case where there is no attribute value possessed by all or a predetermined percentage or more of the persons having the feature.

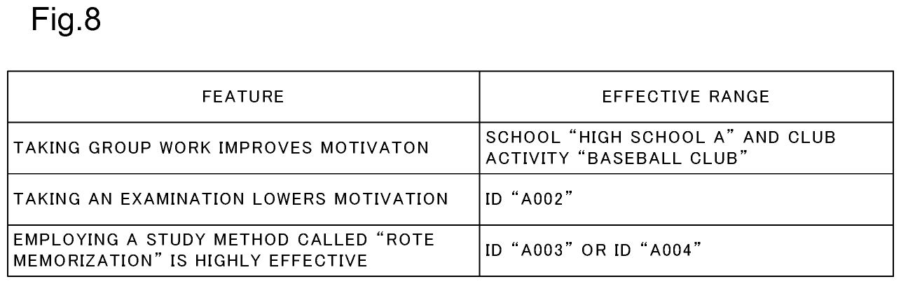

FIG. 8 is a diagram illustrating an example of an effective range determination result in the first example embodiment.

For example, in the database 201 of FIG. 2, it is assumed that all of persons having a feature that “taking group work improves motivation” have, as attribute values, a school “high school A” and a club activity “baseball club”. In this case, the update unit 130, as illustrated in FIG. 8, determines the school “high school A” and the club activity “baseball club” as the effective range of the feature.

In addition, for example, in the database 201 of FIG. 2, it is assumed that there is no attribute value possessed by all of persons having a feature that “taking an examination lowers motivation”. In this case, the update unit 130, as illustrated in FIG. 8, determines an ID “A002” of a person having the feature as the effective range of the feature.

Similarly, it is assumed that there is no attribute value possessed by all of persons having a feature that “employing a study method called “rote memorization” is highly effective”. In this case, the update unit 130, as illustrated in FIG. 8, determines an ID “A003” or “A004” of a person having the feature as the effective range of the feature.

Note that the update unit 130 may extract, when identifying an attribute value for each feature, an attribute value possessed by all or a predetermined percentage or more of the persons having the feature, from among the attribute values that greatly influence the feature. In this case, the influence on the feature by the attribute value can be acquired by, for example, recursive analysis using, for an objective variable, a variable representing the presence or absence of a feature by binarization of True or False and, for an explanatory variable, a variable for the number of attribute values, which similarly represents the presence or absence of each of the attribute values by the binarization.

Next, the update unit 130 updates each of the knowledges acquired in the step S12, based on the effective range of each of the features determined in the step S14 (step S15). Here, the update unit 130 converts the effective range to a logical formula by searching, for each feature, the range vocabulary corresponding to the effective range of the feature from the range vocabulary storage unit 150, and applying the searched range vocabulary to the effective range. The update unit 130 then sets the logical formula of the effective range of the feature in a form of conjunction as a presumptive event of the knowledge corresponding to the feature.

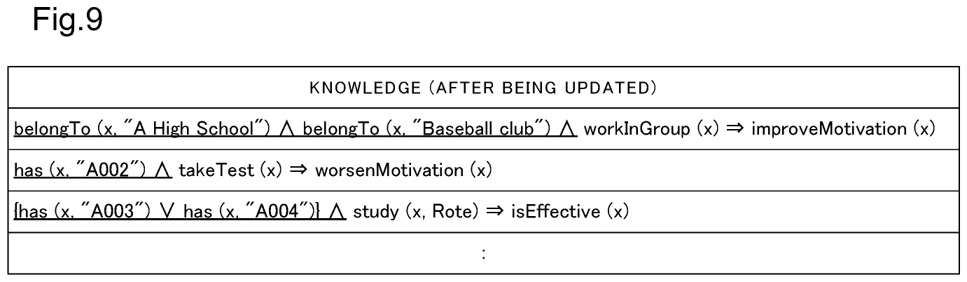

FIG. 9 is a diagram illustrating an example of a knowledge update result in the first example embodiment. For example, the update unit 130, as indicated by an underlined part of each of the knowledges of FIG. 9, updates each of the knowledges by applying the range vocabulary of FIG. 4 to the effective range of each of the features in FIG. 8, and setting the applied range vocabulary as a presumptive event of the corresponding knowledge in FIG. 7.

The update unit 130 outputs the updated knowledge to the knowledge base storage device 300 (step S16).

The knowledge base storage device 300 stores, in the knowledge base 301, the knowledge with the effective range which is output by the knowledge acquisition device 100.

For example, the knowledge base storage device 300 stores the knowledge of FIG. 9 in the knowledge base 301.

Reasoning is performed by using such knowledge with the effective range, which is updated by the knowledge acquisition device 100, and reasoning considering a personal feature can be thereby performed.

Thus, the operation of the first example embodiment is complete.

Next, a basic configuration of the first example embodiment will be described.

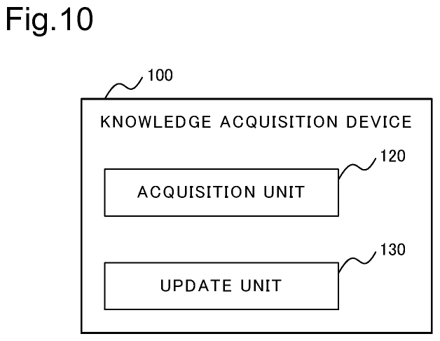

FIG. 10 is a block diagram illustrating the basic configuration of the first example embodiment. Referring to FIG. 10, the knowledge acquisition device 100 includes the acquisition unit 120 and the update unit 130. The acquisition unit 120 acquires knowledge representing a relationship between events relating to a person. The update unit 130 identifies, based on an attribute value possessed by each of a plurality of persons, an attribute value possessed by a person for whom the knowledge holds true among the plurality of persons. The update unit 130 then updates and outputs knowledge in such a way that the knowledge holds true for the person having the identified attribute value.

Next, advantageous effects of the first example embodiment will be described.

According to the first example embodiment, the knowledge for performing reasoning considering personal features can be acquired. This is because the knowledge acquisition device 100 identifies, based on attribute values possessed by each of a plurality of persons, an attribute value possessed by a person for whom knowledge holds true, and updates knowledge in such a way that the knowledge holds true for a person having the identified attribute value. In this manner, the effective range indicating what kind of person or what person group the knowledge is effective for can be represented by a computer recognizable format, and reasoning considering personal features can be performed.

### Second Example Embodiment

Next, a second example embodiment will be described. The second example embodiment is different from the first example embodiment in that a reasoning device 400 (hereinafter, referred to as reasoning engine) performs reasoning based on a knowledge base 301. In addition, in the second example embodiment, the reasoning device 400 performs reasoning, assuming that a person of a knowledge acquisition/update target for which information is stored in a database 201 (hereinafter, referred to as a known person) is a person of a reasoning target.

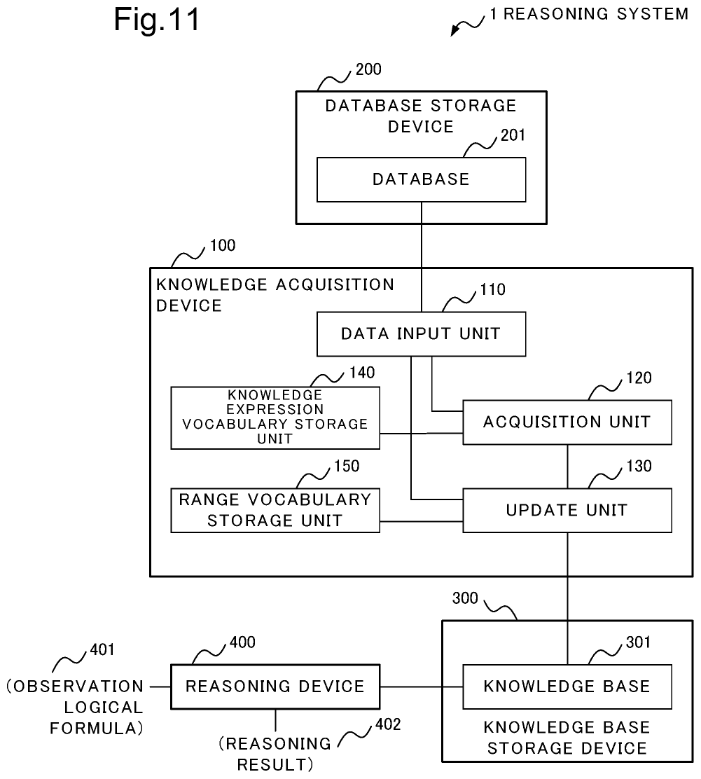

First, a configuration of the second example embodiment will be described. FIG. 11 is a block diagram illustrating the configuration of the second example embodiment. Referring to FIG. 11, a reasoning system 1 includes a knowledge acquisition device 100, a knowledge base storage device 300, and a reasoning device 400. The reasoning device 400 is connected to the knowledge base storage device 300 via a network and the like.

To the reasoning device 400, an observation logical formula 401 for a person of a reasoning target (a known person) is input.

The observation logical formula 401 is a logical formula representing, in a format of first-order predicate logic, an event observed for a person of a reasoning target (a known person) (hereinafter, referred to an observation event). The observation events represented by the observation logical formula 401 include: an event relating to an attribute value possessed by a person of a reasoning target; and an event relating to a situation or a status of the person of the reasoning target.

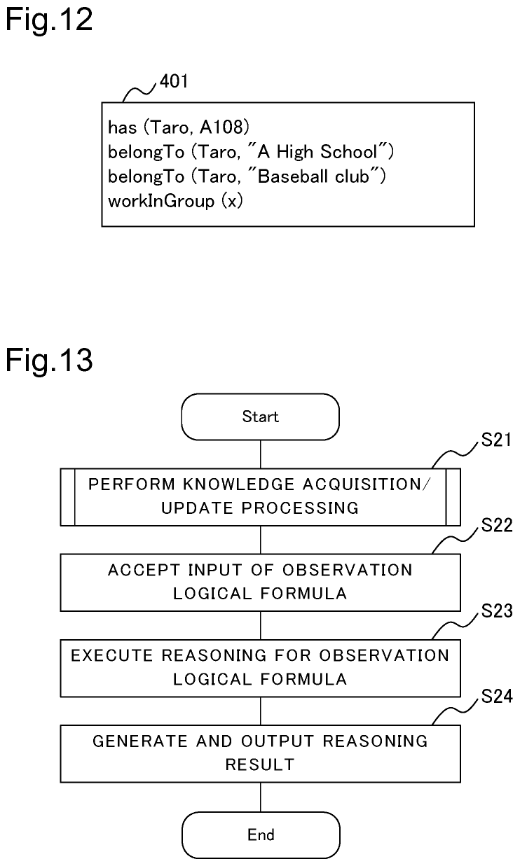

FIG. 12 is a diagram illustrating an example of the observation logical formula 401 in the second example embodiment. The observation logical formula 401 of FIG. 12 represents, as an event relating to an attribute value, the fact that Taro's ID is “A108” and Taro belongs to a “high school A” and a “baseball club”, and represents, as an event relating to the situation or status, the fact that “Taro takes group work”.

The reasoning device 400 executes reasoning for the observation logical formula 401, and outputs a reasoning result 402, based on the knowledge base 301 stored in the knowledge base storage device 300.

The reasoning result 402 is a set of other events derived by reasoning for an observation event. Specifically, the reasoning result 402 indicates “another event that can subsequently take place due to an observation event” or “another event that can cause an observation event to take place”.

Note that as long as reasoning for an observation event can be executed based on the knowledge base 301, the formats of the observation logical formula 401 and the reasoning result 402 may be other formats, and the contents of reasoning may be other contents.

The reasoning device 400 may also be a computer including a CPU and a recording medium that stores a program, and executing an instruction of a program that executes reasoning.

In addition, a part or all of the knowledge acquisition device 100, the database storage device 200, the knowledge base storage device 300, and the reasoning device 400 may be composed of one device.

Next, an operation of the second example embodiment will be described. FIG. 13 is a flowchart illustrating reasoning processing in the second example embodiment.

Here, as in the first example embodiment, it is assumed that the database 201 of FIG. 2 is stored in the database storage device 200. In addition, it is assumed that the knowledge expression vocabulary of FIG. 3 and the range vocabulary of FIG. 4 are respectively stored in the knowledge expression vocabulary storage unit 140 and the range vocabulary storage unit 150.

First, as a preparation in advance, the knowledge acquisition device 100 executes knowledge acquisition/update processing as in the first example embodiment (step S21). In this manner, knowledge with an effective range output from the knowledge acquisition device 100 is stored in the knowledge base 301 of the knowledge base storage device 300. Note that in the knowledge base 301, the knowledge generated based on a common knowledge and the like may be stored in addition to the knowledge output by the knowledge acquisition device 100.

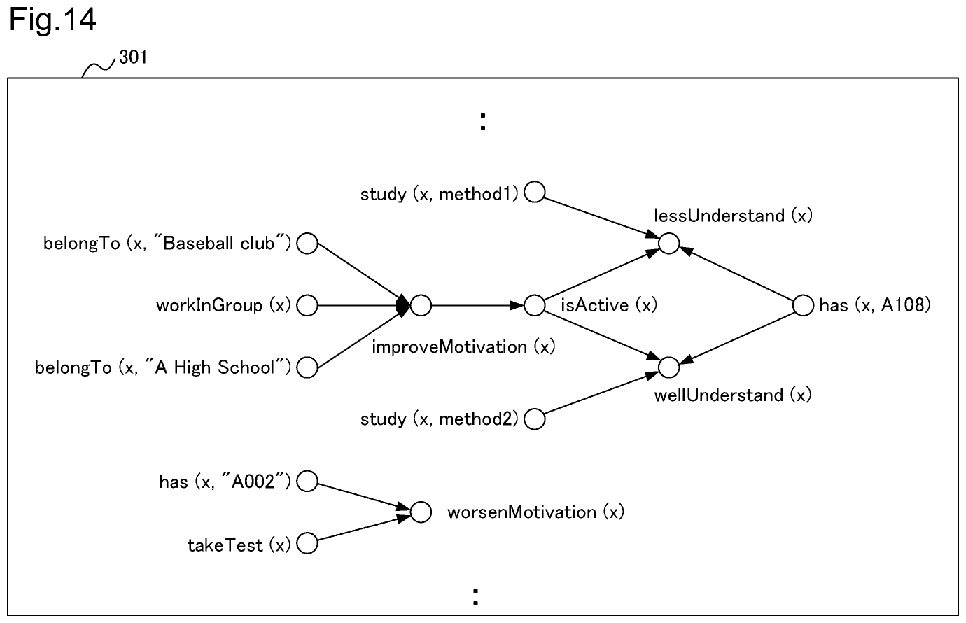

FIG. 14 is a diagram illustrating an example of the knowledges stored in the knowledge base 301 in the second example embodiment. In FIG. 14, a circle mark indicates an event. An arrow between events (circle marks) indicates a relationship that an event in the source of the arrow is presumptive and an event at the tip of the arrow is consequent. In addition, in a case in which the tips of a plurality of arrows are oriented to one event, it is indicated that when all of these events of the sources of the plurality of arrows are true, the event at which the arrows point is true (AND condition).

For example, the knowledge base storage device 300 stores the knowledge base 301 as in FIG. 14, which is output from the knowledge acquisition device 100.

Next, the reasoning device 400 accepts an input of the observation logical formula 401 from a user and the like (Step S22).

For example, the reasoning device 400 accepts an input of the observation logical formula 401 as in FIG. 12.

Note that the reasoning device 400 may accept, in a natural language, an observation event for a person of a reasoning target, and may convert the accepted observation event into a logical formula by using the knowledge expression vocabulary and the range vocabulary as in the knowledge acquisition device 100.

Next, the reasoning device 400 executes reasoning for the input observation logical formula 401, based on the knowledge base 301 stored in the knowledge base storage device 300 (step S23). Here, the reasoning device 400 searches an observation event that corresponds to each of the observation logical formulas 401 among the knowledges of the knowledge base 301. The reasoning device 400 then extracts a “true event” acquired by tracking knowledge (a relationship between events) from the observation events. In addition, the reasoning device 400 may extract an “event that can hold true” by tracking the knowledge in the same way. Further, the reasoning device 400 may extract an “event that should hold true in a case the “event that can hold true” holds true”.

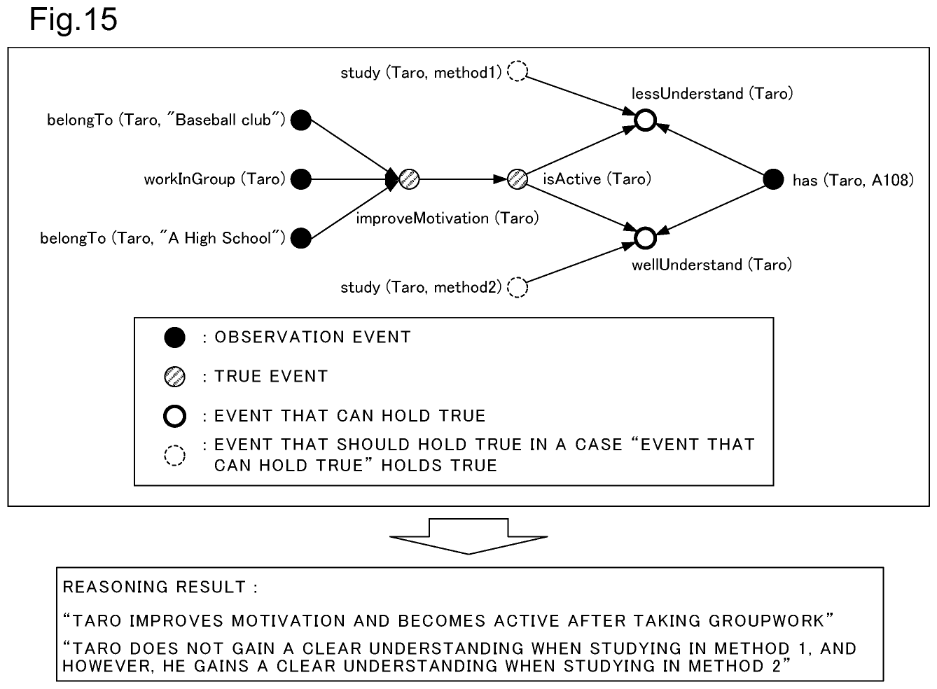

FIG. 15 is a diagram illustrating an example of reasoning in the second example embodiment. In the example of FIG. 15, among the knowledges of the knowledge base 301 of FIG. 14, observation events that correspond to logical formulas included in the observation logical formula 401 of FIG. 12 are indicated by black circle marks. In addition, “true events” acquired by tracking the knowledge from the observation events are indicated by hatched circle marks. Further, “events that can hold true” are indicated by thick circle marks. Furthermore, “events that should hold true in a case “the events that can hold true” hold true” are indicated by dotted circle marks.

For example, the reasoning device 400, as in FIG. 15, extracts each event acquired by tracking knowledge from an observation event.

The reasoning device 400 generates the reasoning result 402, based on each event extracted, and outputs the generated result to a user and the like (step S24).

For example, the reasoning device 400 outputs, based on the “true events” extracted in FIG. 15, the reasoning result 402 that “Taro takes group work, improves motivation, and becomes active”. Further, the reasoning device 400 outputs, based on the “event that can hold true” and the “event that should hold true in a case the “event that can hold true” holds true”, the reasoning result 402 that “Taro does not gain a clear understanding when studying in Method 1, and however, he gains a clear understanding when studying in Method 2.

Thus, the operation of the second example embodiment is complete.

Next, advantageous effects of the second example embodiment will be described.

According to the second example embodiment, reasoning considering personal features can be performed. This is because the reasoning device 400 performs reasoning, based on the knowledge updated by the knowledge acquisition device 100, for the person observation events.

### Third Example Embodiment

Next, a third example embodiment will be described. The third example embodiment is different from the second example embodiment in that a reasoning device 400 performs reasoning, assuming that a new person other than a person of a knowledge acquisition/update target for which information is stored in a database 201 (a known person) is a person of a reasoning target.

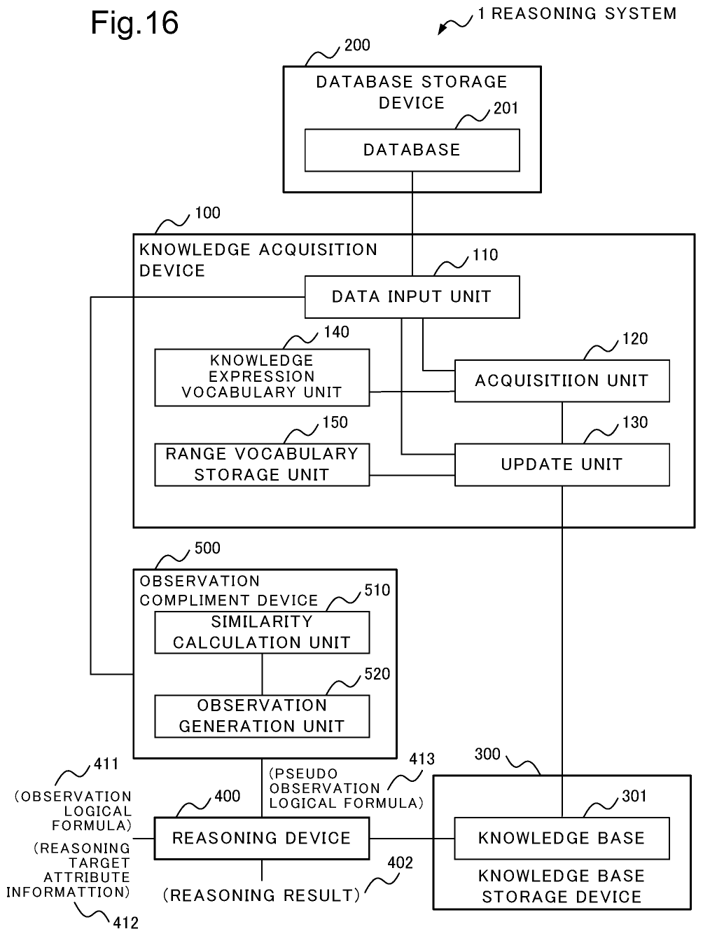

First, a configuration of the third example embodiment will be described. FIG. 16 is a block diagram illustrating the configuration of the third example embodiment. Referring to FIG. 16, a reasoning system 1 includes an observation compliment device 500 in addition to the constituent elements of the second example embodiment. The observation compliment device 500 is connected to a knowledge acquisition device 100 and a reasoning device 400 via a network and the like.

To the reasoning device 400, an observation logical formula 411 and reasoning target attribute information 412 are input for a person of a reasoning target (a new person).

The observation logical formula 411 is a logical formula representing, in the format of one-floor predicate logic, an event observed for the person of the reasoning target (new person). The observation events represented by the observation logical formula 411 include an event relating to a situation or a status of the person of the reasoning target.

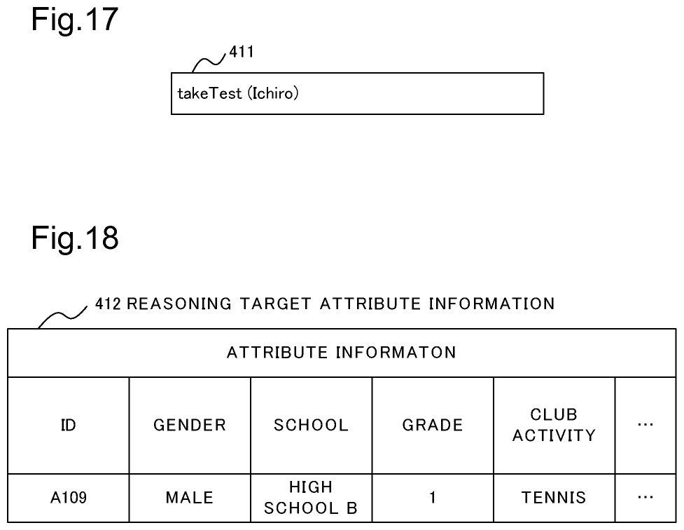

FIG. 17 is a diagram illustrating an example of the observation logical formula 411 in the third example embodiment. The observation logical formula 411 of FIG. 17 represents, as an event relating to the situation or the status, the fact that “Ichiro has taken an examination”.

The reasoning target attribute information 412 is attribute information of the person of the reasoning target (new person). An attribute value of the person of the reasoning target is set for an attribute identical to each of the attributes of the attribute information in the database 201.

FIG. 18 is a diagram illustrating an example of the reasoning target attribute information 412 in the third example embodiment. In the reasoning target attribute information 412 of FIG. 18, the attribute value of the person of the reasoning target is set for an attribute identical to each of the attributes of the attribute information of FIG. 2.

As described later, in the observation compliment device 500, a known person of which attribute information is similar to that of the reasoning target attribute information 412 is identified, and an observation logical formula relating to an attribute value of the identified person (hereinafter, referred to as pseudo observation logical formula 413) is generated.

The reasoning device 400 assumes that an event represented by the observation logical formula 411 is observed for a known person having attribute information similar to that of the person of the reasoning target, and executes reasoning for the observation logical formula 411 and the pseudo observation logical formula 413.

The observation compliment device 500 includes a similarity calculation unit 510 and an observation generation unit 520.

The similarity calculation unit 510 calculates a similarity between the reasoning target attribute information 412 and the attribute information of a known person, and identifies a known person of which attribute information is similar to the reasoning target attribute information 412.

The observation generation unit 520 generates the pseudo observation logical formula 413, based on the attribute information of the person identified by the similarity calculation unit 510.

Note that the observation compliment device 500 may also be a computer including a CPU and a recording medium that stores a program, and executing an instruction of a program for implementing functions of the similarity calculation unit 510 and the observation generation unit 520.

In addition, a part or all of the knowledge acquisition device 100, the database storage device 200, the knowledge base storage device 300, the reasoning device 400, and the observation compliment device 500 may be composed of one device.

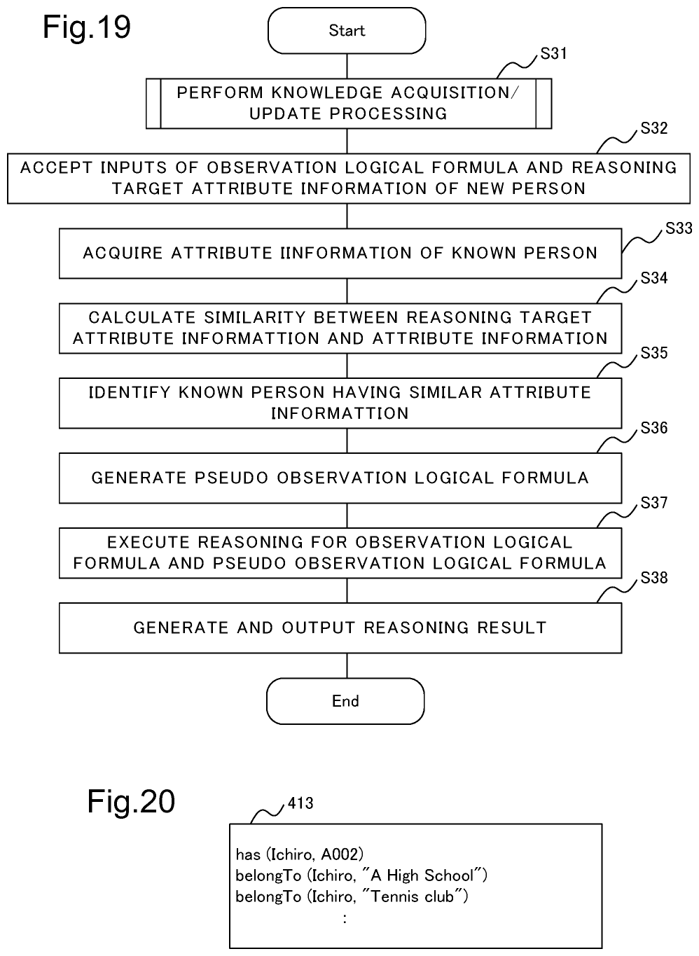

Next, an operation of the third example embodiment will be described. FIG. 19 is a flowchart illustrating reasoning processing in the third example embodiment.

Here, as in the second example embodiment, it is assumed that the database 201 of FIG. 2 is stored in the database storage device 200. In addition, it is assumed that the knowledge expression vocabulary of FIG. 3 and the range vocabulary of FIG. 4 are respectively stored in the knowledge expression vocabulary storage unit 140 and the range vocabulary storage unit 150.

First, as in the step S21 of the second example embodiment, the knowledge acquisition device 100 executes knowledge acquisition/update processing as in the first example embodiment (step S31).

For example, the knowledge base storage device 300 stores the knowledge base 301 as in FIG. 14, which is output from the knowledge acquisition device 100.

Next, the reasoning device 400 accepts inputs of the observation logical formula 411 and the reasoning target attribute information 412 of a new person from a user and the like (step S32). The reasoning device 400 transmits the reasoning target attribute information 412 to the observation compliment device 500.

For example, the reasoning device 400 accepts inputs of the observation logical formula 411 and the reasoning target attribute information 412 as in FIGS. 17 and 18.

The similarity calculation unit 510 of the observation compliment device 500 acquires the attribute information of each of the known persons in the database 201 via the data input unit 110 of the knowledge acquisition device 100 (step S33).

For example, the similarity calculation unit 510 acquires the attribute information in the database 201 of FIG. 2.

The similarity calculation unit 510 calculates similarity between the reasoning target attribute information 412 and the attribute information of the known person (step S34). Here, assuming that a vector representing the attribute value of the reasoning target attribute information 412 is V_A, and a vector representing the attribute value of the attribute information of the known person is V_B, the similarity is calculated by an inner product of V_A and V_B (cosine similarity), for example. In elements of the vectors V_A and V_B, a variable representing the presence or absence of the attribute value (whether or not to have the attribute value) by binarization of True or False is used for each of the attribute values respectively set for the attributes of the attribute information in the database 201. In this case, the order number of the vectors V_A and V_B is equal to the number of attribute values in the database 201. It can be determined that the reasoning target attribute information 412 and the attribute information of the known person are similar to each other, as the value of similarity comes closer to 1.

The similarity calculation unit 510 identifies, based on the similarity calculated in the step S34, the known person of which attribute information is similar to that of the reasoning target attribute information 412 (step S35). Here, the similarity calculation unit 510 identifies the known person of which similarity is a predetermined value or more, for example. In addition, the similarity calculation unit 510 may identify a person of which similarity is maximal or a known person of which similarity is a predetermined value or more and maximal.

For example, the similarity calculation unit 510 identifies the ID “A002” of a known person of which attribute information is similar to that of the reasoning target attribute information 412, based on the reasoning target attribute information 412 of FIG. 18 and the attribute information in the database 201 of FIG. 2.

The observation generation unit 520 generates the pseudo observation logical formula 413, based on the attribute information of the person identified by the similarity calculation unit 510, and outputs the generated logical formula to the reasoning device 400 (step S36). Here, the observation generation unit 520 generates, as the pseudo observation logical formula 413 of the person of the reasoning target, the observation formula relating to each of the attribute values which is possessed by the identified person.

FIG. 20 is a diagram illustrating an example of the pseudo observation logical formula 413 in the third example embodiment.

For example, the observation generation unit 520 generates the pseudo observation logical formula 413 as in FIG. 20, based on the attribute information of the person of the ID “A002” in the database 201 of FIG. 2.

The reasoning device 400 executes reasoning for the observation logical formula 411 and the pseudo observation logical formula 413, as in the step S23 of the second example embodiment (step S37).

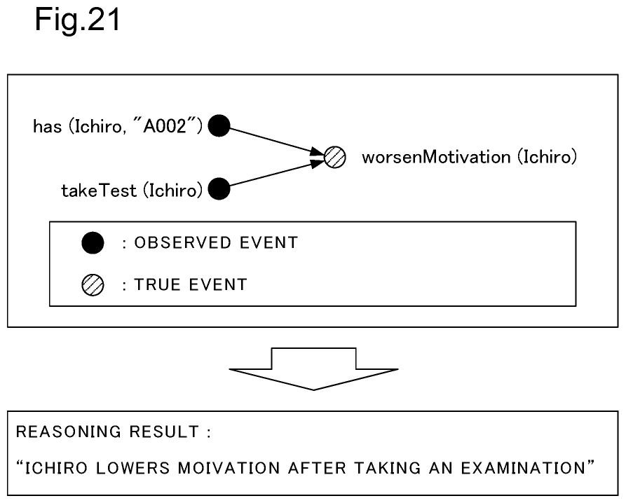

FIG. 21 is a diagram illustrating an example of reasoning in the third example embodiment.

For example, the reasoning device 400 extracts, as in FIG. 21, an event acquired by tracking knowledge from observation events.

The reasoning device 400 generates the reasoning result 402, based on each of the extracted events, and outputs the generated reasoning result to a user and the like (step S38).

For example, the reasoning device 400 outputs, based on the event of the “true event” extracted in FIG. 21, the reasoning result 402 that “Ichiro lowers motivation after taking an examination”.

Thus, the operation of the third example embodiment is complete.

Note that in the foregoing description, the observation compliment device 500 has identified the known person of which attribute information is similar to that of the reasoning target attribute information 412. However, without being limited thereto, the observation compliment device 500 may identify a group of known persons of which attribute information is similar to the reasoning target attribute information 412. In this case, the group is designated by a specific attribute by a user and the like, for example. In the attribute information of the database 201, a person having an identical attribute value for the designated attribute is then classified into an identical group. In the step S34, the similarity calculation unit 510 also calculates the similarity between the reasoning target attribute information 412 and the attribute information of the group. Here, the attribute information of the group can be acquired by calculating, for each of the attributes included in the attribute information, for example, an average of the attribute values for the persons in the group. In addition, in the step S35, the similarity calculation unit 510 identifies a group of which attribute information is similar to the reasoning target attribute information 412. Further, in the step S36, the observation generation unit 520 generates, as the pseudo observation logical formula 413 of the person of the reasoning target, an observation formula relating to the attribute values possessed by all of the persons in the identified group, for example.

Next, advantageous effects of the third example embodiment will be described.

According to the third example embodiment, reasoning considering personal features can be also performed for a new person other than a person of a knowledge acquisition/update target. This is because the reasoning device 400 performs reasoning, assuming that an event indicating possession of an attribute value of a known person of which attribute value is similar to that of a new person and an event relating to a situation or a status of the new person are observation events of the new person.

While the invention has been particularly shown and described with reference to exemplary embodiments thereof, the present invention is not limited to these embodiments. It will be understood by those of ordinary skill in the art that various changes in form and details may be made therein without departing from the spirit and scope of the present invention as defined by the claims.

In the foregoing example embodiments, for example, a case in which the knowledge used for reasoning is the knowledge relating to learning in the learning service has been described by way of example. However, the knowledge used for reasoning may be another knowledge other than the learning service, as long as the knowledge is knowledge representing a relationship between events relating to a situation or a status of a person.

### INDUSTRIAL APPLICABILITY

The present invention can be broadly applied to service that performs reasoning for an event observed with respect to a situation or a status of a person. For example, the present invention can be applied to usage that presents, in an educational service, appropriate teaching activity or learning activity according to a situation or a status of an individual learner. In addition, the present invention can be applied to usage that presents, in a medical service or a care service as well, appropriate measures for stress reduction according to a situation or a status of a patient or an individual cared.

### REFERENCE SIGNS LIST

1 Reasoning system
100 Knowledge acquisition device
101 CPU
102 Storage device
103 Input/output device
104 Communication device
110 Data input unit
120 Acquisition unit
130 Update unit
140 Knowledge expression vocabulary storage unit
150 Range vocabulary storage unit
200 Database storage device
201 Database
300 Knowledge base storage device
301 Knowledge base
400 Reasoning device
401 Observation logical formula
402 Reasoning result
411 Observation logical formula
412 Reasoning target attribute information
413 Pseudo observation logical formula
500 Observation compliment device
510 Similarity calculation unit
520 Observation generation unit

1. A knowledge acquisition device comprising:
a memory storing instructions; and
one or more processors configured to execute the instructions to:
acquire knowledge representing a relationship between events relating to persons; and
identify, based on an attribute value possessed by each of a plurality of persons, an attribute value possessed by a person for whom the knowledge holds true among the plurality of persons, update the knowledge in such a way that the updated knowledge holds true for a person having the identified attribute value, and output the updated knowledge.

2. The knowledge acquisition device according to claim 1, wherein
the knowledge includes a presumptive event and a consequent event, and
the knowledge is updated by adding, as a conjunction, an event indicating possession of the identified attribute value to the presumptive event in the knowledge.

3. The knowledge acquisition device according to claim 1, wherein
an attribute value influencing a relationship between the events is identified, among attribute values possessed by a person for whom the knowledge holds true among the plurality of persons, and the knowledge is updated in such a way that the knowledge holds true for a person having the identified attribute value.

4. A reasoning system comprising:
the knowledge acquisition device according to claim 1; and
a reasoning device that performs reasoning for an event that is observed for a person, based on knowledge that is updated by the knowledge acquisition device.

5. The reasoning system according to claim 4, wherein
the reasoning device performs reasoning, assuming, for any person among the plurality of persons, that an event indicating possession of an attribute value of the person, and an event relating to a situation or a status of the person are events observed for the person.

6. The reasoning system according to claim 4, wherein
the reasoning device performs reasoning, assuming, for a new person, that an event indicating possession of an attribute value of a person being identified from the plurality of persons and having an attribute value that is similar to an attribute value of the new person, and an event relating to a situation or a status of the new person are events observed for the new person.

7. A knowledge acquisition method comprising:
acquiring knowledge representing a relationship between events relating to persons;
identifying, based on an attribute value possessed by each of a plurality of persons, an attribute value possessed by a person for whom the knowledge holds true among the plurality of persons;
updating the knowledge in such a way that the updated knowledge holds true for a person having the identified attribute value; and
outputting the updated knowledge.

8. A non-transitory computer readable storage medium recording thereon a program, causing a computer to execute processes comprising:
acquiring knowledge representing a relationship between events relating to persons;
identifying, based on an attribute value possessed by each of a plurality of persons, an attribute value possessed by a person for whom the knowledge holds true among the plurality of persons;
updating the knowledge in such a way that the updated knowledge holds true for a person having the identified attribute value; and
outputting the updated knowledge.
